(19) United States
(12) Patent Application Publication
(10) Pub. No.: US 2006/0179628 A1
(43) Pub. Date: Aug. 17, 2006

(54) Joining device and joining process

(76) Inventor: Thomas Sturm, WIEDENZHAUSEN (DE)

Correspondence Address: MCGLEW & TUTTLE, PC, P.O. BOX 9227, SCARBOROUGH STATION, SCARBOROUGH, NY, 10510-9227, US

(21) Appl. No.: 10/547,434

(22) PCT Filed: Mar. 4, 2004
(86) PCT No.: PCT/EP04/02151

§ 371 Date: Aug. 25, 2005

(30) Foreign Application Priority Data
Mar. 6, 2003 (DE) 103 10 194.2

(51) Int. Cl. B23Q 7/00

(52) U.S. Cl. 29/33 P

(57) ABSTRACT

A joining method and to a joining device (1) for joining roof skins (11) to parts (4) of vehicle bodies (3) is provided. The joining device (1) includes one or more joining grippers (2), which are comprised of at least one frame (24), of a number of gripping elements (29, 30), of at least one pressing strip (27), which acts upon the roof skin (11), and of an associated adjusting device (32). The pressing strip (27) is adapted to the joining contour (6) of the part (4) and has one or more dimensionally stable strip segments (33, 34, 35, 36, 37) that, independent of one another, are mounted on a strip support (26) with a limited flexibility in the direction of adjustment (41). The roof skin (11) with the joining part edge (13) thereof, is pressed against and fixed to the contact area (7) of the part (4) by means of the strip segments (33, 34, 35, 36, 37) and, optionally, is permanently deformed.

### CROSS REFERENCE TO RELATED APPLICATIONS

This application is a United States National Phase application of International Application PCT/EP2004/002151 and claims the benefit of priority under 35 U.S.C. § 119 of German Application DE 103 10 194.2 filed Mar. 6, 2003, the entire contents of which are incorporated herein by reference.

### FIELD OF THE INVENTION

The present invention pertains to a joining means and a joining process for parts to be joined, especially roof panels.

### BACKGROUND OF THE INVENTION

Such a joining means with a joining process is known from DE-A-100 61 309. The technique is used to join roof panels on side panels of vehicle bodies by means of a joining gripper. The joining gripper comprises a robot-guided frame with a plurality of suction grippers and peripherally arranged pressing tubes acting on the part to be joined. The longitudinally extending edges of the roof panel shall be pressed with these pressing tubes against the supports at the side panels, and a permanent deformation or damage to the roof panel is to be avoided. The pressing tube extending over the entire length of the roof panel ensures a pressure that is constant everywhere, which is useful for the prevention of deformation, but, on the other hand, does not guarantee reliable contact of the roof panel with the supports of the side panels. After the roof panel has been connected to the side panels by laser soldering, this insufficient pressing may lead to problems due to the formation of gaps, especially if the side parts of the body have position tolerances and are directed, e.g., crooked with their supports. The soldered connection may be insufficient in this case.

### SUMMARY OF THE INVENTION

The object of the present invention is to provide an improved joining technique.

This object is accomplished by the present invention. The joining gripper of a preferred embodiment of the pressing strip has the advantage that the part to be joined, e.g., a roof panel, can be placed on one or more components, e.g., side panels of vehicle bodies, substantially better and with a greater accuracy of fit. Permanent deformations of the part to be joined can be accepted now especially because they are not visible on the finish-painted body. Reliable contact with an accurate gap is possible along the entire joining contour due to the pressing strip adapted to the joining contour, and all possible position and shape tolerances of the components can be absorbed. In addition, the accurate contact of the joined part ensures better fixing, e.g., by laser soldering, laser welding, bonding or the like.

The division of the pressing strip into a plurality of strip segments has the advantage of better and more accurate adaptation of the shape to the existing joining contour of the components. Moreover, local tolerances can be absorbed better and more reliably. The mutually independent, flexible mounting of the strip segments is advantageous for this. The pressing force of the individual segments of the strip is guaranteed by corresponding spring elements. Contrary to the prior-art pressing tube, the pressing force and the active shaping can now be applied in a targeted manner in the needed areas of the joining contour that are subject to tolerance due to the dimensional stability of the pressing strip.

The joining means according to the present invention makes it, furthermore, possible not only to place and press on the part to be joined, e.g., a roof panel, loosely on the components, especially the side panels of the body, but also to create a positive-locking connection, e.g., a snap connection.

Gripping elements that can be controlled in different ways, preferably suction grippers, may be present for this in the inner area and on the periphery of the joining gripper, which permit the part to be joined to arch over and thus its contour to narrow for positioning at the connection site. During the subsequent elimination of the arching, the part to be joined snaps by itself into a corresponding concave mount at the components. A deliberate arching of the roof panel may also serve other purposes, e.g., in case of a deliberately oblique positioning of the edges of the part to be joined at the components.

The joining means according to the present invention makes it, furthermore, possible to grip the parts to be joined in an accurately fitting manner and to accurately position and center them for the subsequent fixing or permanent connection. Corresponding guides and a centering device oriented toward the component, especially the joining contour of the component, are advantageous for this.

The joining technique according to the present invention also has above all the advantage of high flexibility and adaptation to the desired tolerance specifications. The part to be joined may be optionally joined in reference to a network or in reference to the component. The reference to the component depends on the existing position and orientation of the components, even if this happens to be incorrect and not in reference to a network. The smallest deformations and stresses occur in case of this joining technique. The joining technique according to the present invention is therefore highly flexible and can be adapted to the particular specifications and needs of the manufacturer and the operator.

The present invention is schematically shown in the drawings as an example. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a perspective view of a joining gripper according to the invention;

FIG. 2 is a perspective view of an individual component of the joining gripper from FIG. 1;

FIG. 3 is a perspective view of an individual component of the joining gripper from FIG. 1;

FIG. 4 is a perspective view of an individual component of the joining gripper from FIG. 1;

FIG. 5 is a side view of a joining device in a machining station;

FIG. 6 is a rear view according to arrow VI in FIG. 5;

FIG. 7 is a top view according to arrow VII in FIG. 5;

FIG. 8 is an enlarged side view of a joining gripper in the joining position at a vehicle body;

FIG. 9 is a cross section through a pressing strip of the joining gripper in FIG. 8;

FIG. 10a is a view showing a joining process step 1;

FIG. 10b is a view showing a joining process step 2;

FIG. 10c is a view showing a joining process step 3;

FIG. 10d is a view showing a joining process step 4;

FIG. 10e is a view showing a joining process step 5;

FIG. 10f is a view showing a joining process step 6;

FIG. 11 is a side view of a variant of the machining station from FIG. 5 with another feed device for the joining gripper;

FIG. 12a is a view showing step 1 of a five steps variant of the joining sequence in FIG. 10;

FIG. 12b is a view showing step 2 of a five steps variant of the joining sequence in FIG. 10;

FIG. 12c is a view showing step 3 of a five steps variant of the joining sequence in FIG. 10;

FIG. 12d is a view showing step 4 of a five steps variant of the joining sequence in FIG. 10;

FIG. 12e is a view showing step 5 of a five steps variant of the joining sequence in FIG. 10;

FIG. 13 is a view of a different embodiment of the part to be joined and the component at the connection and joining site;

FIG. 14 is a view of another different embodiment of the part to be joined and the component at the connection and joining site;

FIG. 15 is a view of another different embodiment of the part to be joined and the component at the connection and joining site;

FIG. 16 is a view of another different embodiment of the part to be joined and the component at the connection and joining site;

FIG. 17 is a view of another different embodiment of the part to be joined and the component at the connection and joining site;

FIG. 18 is a view of another different embodiment of the part to be joined and the component at the connection and joining site;

FIG. 19 is a view of another different embodiment of the part to be joined and the component at the connection and joining site;

FIG. 20 is a view of another different embodiment of the part to be joined and the component at the connection and joining site;

FIG. 21 is a top view of a part to be joined with a plurality of centering sites;

FIG. 22 is a front view of a centering device for the part to be joined with a plurality of centering units;

FIG. 23 is a view showing a centering unit in an operating position during the centering operation;

FIG. 24 is a view showing a centering unit in another operating position during the centering operation; and

FIG. 25 is a view showing a centering unit in another operating position during the centering operation.

### DESCRIPTION OF THE PREFERRED EMBODIMENT

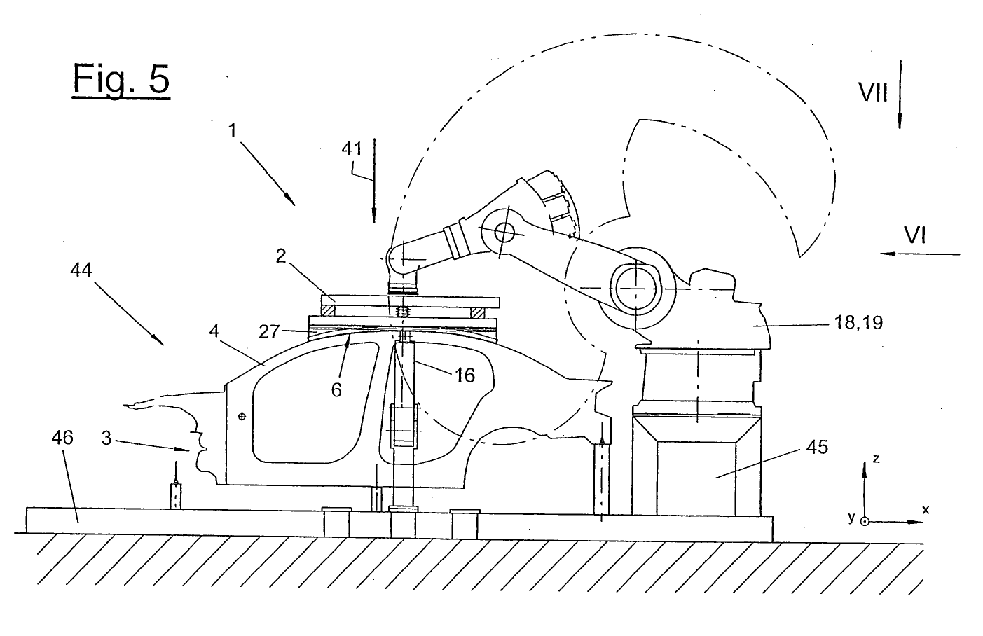

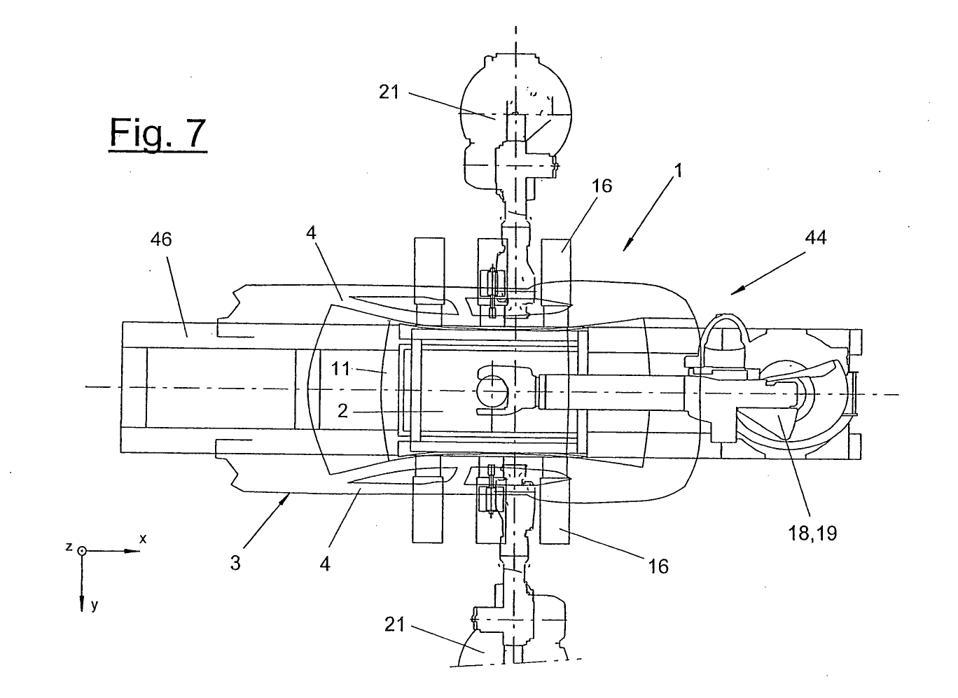

Referring to the drawings in particular, FIGS. 5 through 7 and 11 show different embodiments of a machining station (44) with a joining device (1). The machining station (44) is part of a manufacturing plant for bodies (3) or body shells of vehicles and may be present as several copies and integrated in a transfer line in this case. The body (3) comprises, e.g., a floor group (not shown) and one or more components (4), here two side panel parts, which are optionally connected to one another and stiffened by an inserted roof bow (not shown) in the area of the roof. The body is held by a component mount (46), e.g., a pallet and transported along the transfer line.

A part to be joined (I 1), which comprises, e.g., a thin-walled and optionally preformed roof panel, is joined with the joining device (1) on the body (4) [sic—Tr.Ed.] or the side panel parts (4). It is now fed to the joining site, positioned in a position that is correct for the joining there, held firmly in this position and subsequently fastened by welding, soldering or according to another connection technique. The joining device (1) brings about at least the steps of positioning and holding in the correct position for joining. Moreover, it can also take care of the feeding. The connection technique may be arranged and carried out separately. However, it may also be connected to the joining device (1).

Other parts to be joined, e.g., side panels or the like, may also be joined with the body (3) and the components (4) thereof in the same manner or in a similar manner. Furthermore, panels and other parts to be joined can be joined with body shells, e.g., van bodies, of vehicles in a corresponding manner.

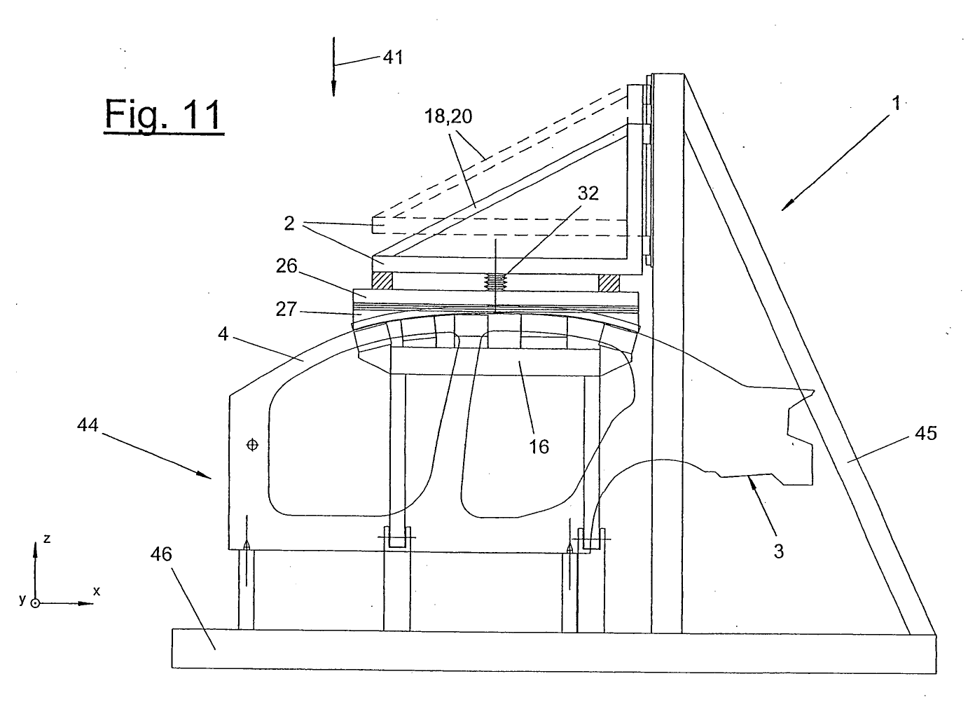

In the different exemplary embodiments, the joining device (1) contains a joining gripper (2), which is moved and actuated by a feed means (18). The joining gripper (2) may also be present in a plurality of copies. In the variant according to FIGS. 5 through 7, the feed means (18) comprises a multiaxial robot (19), preferably a six-axis articulated arm robot, which is mounted at the station frame (45), e.g., on a bottom-side base. As an alternative, it may also be a portal robot. In the variant according to FIG. 11, the feed means (18) is designed as a feed carriage (20), which is guided and movably mounted on a carrying means, e.g., the station frame (45) in the direction of joining or the direction of feed (41). The feed means (41) coincides with the z axis in the exemplary embodiment shown. The feed carriage (20) has no degrees of freedom in the x and y axes.

For joining, the part to be joined (11), which will hereinafter be referred to as roof panel for simplicity's sake, had already been placed on the body (3) in a preceding work station. As an alternative, the roof panel (11) may also be fed by the joining gripper (2), which is loaded before the joining operation in a suitable manner for this.

The components (4), which will hereinafter be referred to as side panels (4), have a predetermined joining contour (6) for the roof panel (11). This joining contour (6) is defined, for example, by a rabbet (5) of the side panel profile, which is shown in greater detail in different shape variants in FIGS. 13 through 20. This rabbet (5) offers a contact area (7), at which the roof panel (11) with its edge (13) is positioned in a suitable manner during the joining operation. As is illustrated by the side views in FIGS. 5, 11 and 8, the joining contour (6) may have a course bent in the longitudinal direction or in the direction of the x axis. The joining contour (6) may have different dimensional and position deviations. For example, its arch may vary, and differences may also occur in the shape of the joining contour (6) between the two side panels (4), especially if the side panels (4) are directed crooked in relation to one another. The tolerances and shape deviations may occur in all three axes x, y and z both in a translatory manner and in a rotatory manner. These tolerances and dimensional or position deviations can be compensated with the joining technique described below.

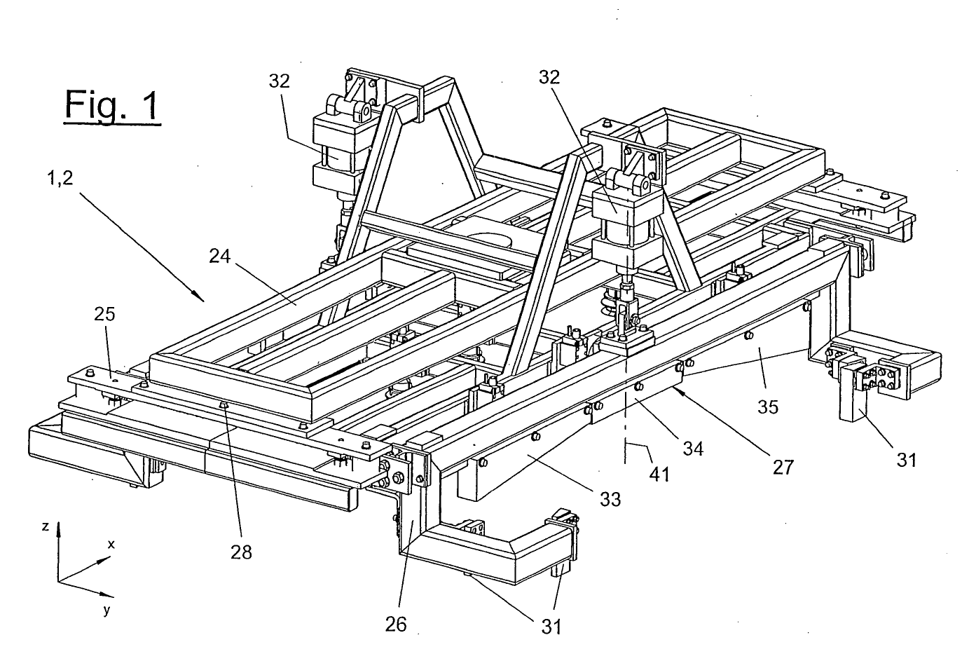

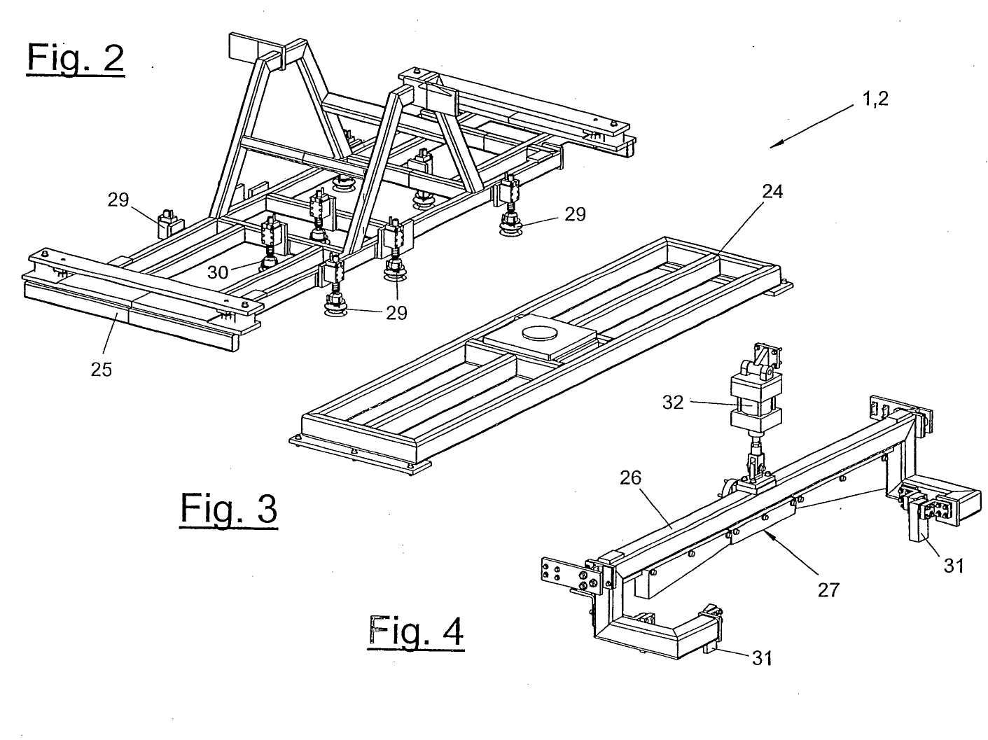

FIGS. 1 through 4 show perspective views of the joining gripper (2). FIG. 1 illustrates the assembly situation, while FIGS. 2 through 4 show the individual components of the gripper separately.

The joining gripper (2) comprises a basic frame (24), on which the feed means (18) or the robot (19) or the feed carriage (20) act in a suitable manner. The basic frame (24) has, for example, a central docking site for connection with the robot hand, and this connection may optionally be detachable by means of a change coupling. A floating frame (25) is arranged preferably hangingly at the basic frame (24) and is mounted in a limitedly movable manner. The floating frame (25) may be temporarily pinned and fixed during rapid movements during transportation or the like. The movable mounting offers limited degrees of freedom in the x and/or y axis and may be embodied by buffers (28), vibration dampers or the like. A plurality of gripping elements (29, 30) for the roof panel (11), which are preferably suction grippers with elastically mounted suction cups, are arranged at the floating frame (25). The gripping elements (29, 30) are preferably mounted in a limitedly movable manner in the direction of feed (41) only, here in the direction of the z axis, and are laterally guided. As an alternative, the gripping elements (29, 30) may be formed from magnetic grippers or other suitable elements for holding the roof panel (11) accurately in position without damaging it.

Two pressing strips (27) with feed devices (32) are arranged at the floating frame (25), preferably at the two long sides thereof, on the outer side in front of the gripping elements (29, 30). The pressing strips (27) are used to press the longitudinally extending roof edges (13) at the joining contour (6). The feed devices (32) are supported at the floating frame (25) via support blocks and are equipped, for example, with pneumatic cylinders or other drive elements. The pressing strips (27) are guided movably (not shown) at the floating frame (25) in the direction of feed (41). The direction of action of the feed devices (32) likewise extends in the direction of feed (41).

In a variant of the embodiment shown, the number and the arrangement of the pressing strips (27) may vary. For example, one or more alternative or additional pressing strips (not shown) located crosswise and extending in the direction of the y axis may be present. Frame guides (31), which engage the side panels (4) during the feeding of the joining gripper (2) and bring the floating frame (25) and the pressing strips (27) into the lateral and vertical position that is correct for the joining in relation to the body (3), may be arranged at the floating frame (25) and/or at the pressing strip or pressing strips (27) via suitable extension arms or the like. The frame guides (31) may have lateral stops for lateral centering and supports for the vertical positioning.

The pressing strip (27) is adapted to the particular corresponding joining contour (6) of the component (4). It has one or more dimensionally stable strip segments (33, 34, 35, 36, 37). The dimensionally stable strip segments (33, 34, 35, 36, 37) are rigid especially in the direction of pressing and are not deformable. They have a predetermined, fixed shape, which does not change during pressing, contrary to the prior-art pressing tubes.

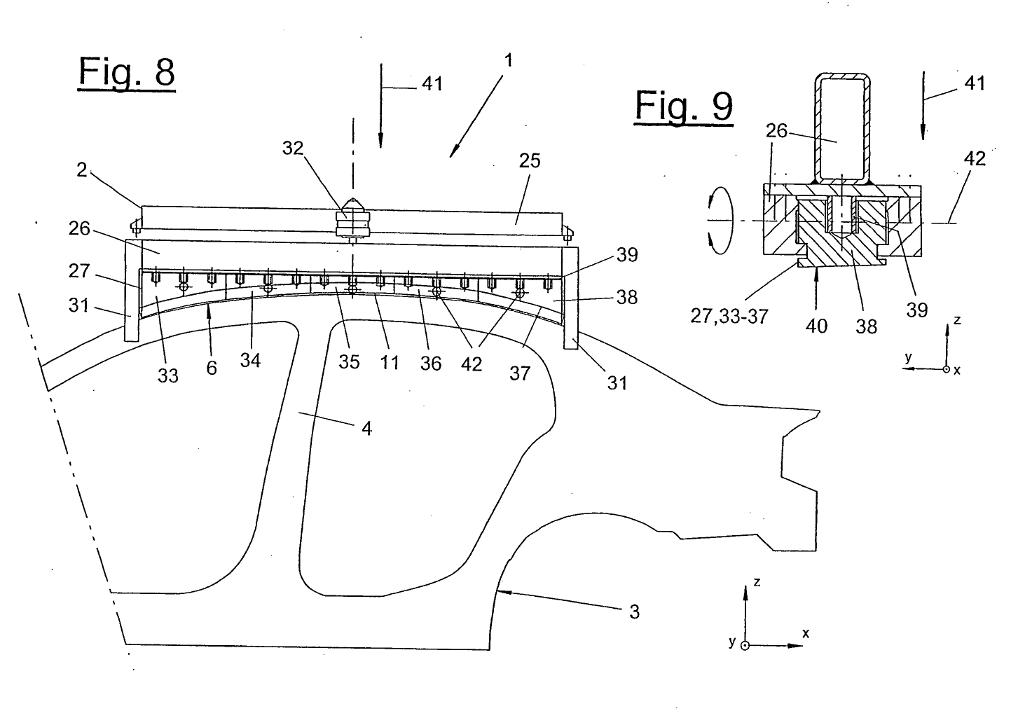

For example, three strip segments (33, 34, 35) are present in the variant according to FIGS. 1 through 4. The pressing strip (27) in FIG. 8 has five strip segments (33, 34, 35, 36, 37). The strip segments (33, 34, 35, 36, 37) are arranged in a row one after another along the joining contour (6) and join each other closely. Due to their dimensional stability, the strip segments (33, 34, 35, 36, 37) can transmit the feeding and pressing force exerted by the feed device (32) specifically to the roof panel (11) and bring this into the desired contact with the joining contour (6). Unlike in the case of a pressing tube, the pressing forces are not distributed toward the side when local resistances occur, but are transmitted at the desired site corresponding to the purpose and correctly for joining.

As is shown in FIGS. 8 and 9, the individual pressing strip (27) preferably comprises a longitudinally stretched strip carrier (26), which is connected to the feed device (32). The strip segments (33, 34, 35, 36, 37) are mounted and guided with limited linear flexibility in the direction of feed (41) at the strip carrier (26), preferably independently from one another. In addition, the strip segments (33, 34, 35, 36, 37) may be mounted, independently from one another, such that they have a limited pivotability and flexibility about a tilt axis (42) extending at right angles to the longitudinal axis of the pressing strip (27). As a result, a tilting or rotary movement is possible for adaptation to the position and the arch of the joining contour (6). The guiding and the limitedly flexible mounting of the strip segments (33 through 37) may be embodied in any desired suitable manner.

In the exemplary embodiment shown in FIG. 9, the strip segments (33 through 37) comprise dimensionally rigid moldings (38) made of plastic or another suitable material, optionally also a composite, which have a pressing surface (40) adapted on the underside to the joining contour (6). The adaptation of the shape consists of the shaping of the pressing surface (4), e.g., an arch of the joining contour (6) in the longitudinal direction or in the direction of the x axis. In the transverse direction or the direction of the y axis, the pressing surfaces (40) may have an oblique position, which corresponds to the position or the arch of the roof panel (11) in the transverse direction and which is adapted to the desired joining shape for the roof panel (11). The pressing surfaces (40) are smooth and preferably have low friction, so that the roof panel (11) may optionally perform a sliding relative movement during pressing on.

The moldings (38) are mounted on the strip carrier (26) movably in the direction of the z axis or the direction of feed (41) and are guided for this purpose at corresponding lateral shaping jaws of the strip carrier (26) and held in the downward direction. The moldings (38) or strip segments (33 through 37) may be mounted and supported now individually elastically on the strip carrier (26). For example, three compression springs (39), which act in the direction of feed (41) and engage corresponding mounts on the upper side of the moldings (38) with a lateral clearance, are present for this purpose for each segment or molding (38). The rotary movement or oblique position mentioned in relation to the tilt axis (42) is possible due to the clearance. The spring elements (39) may be pretensioned in order to provide the necessary or desired pressing force.

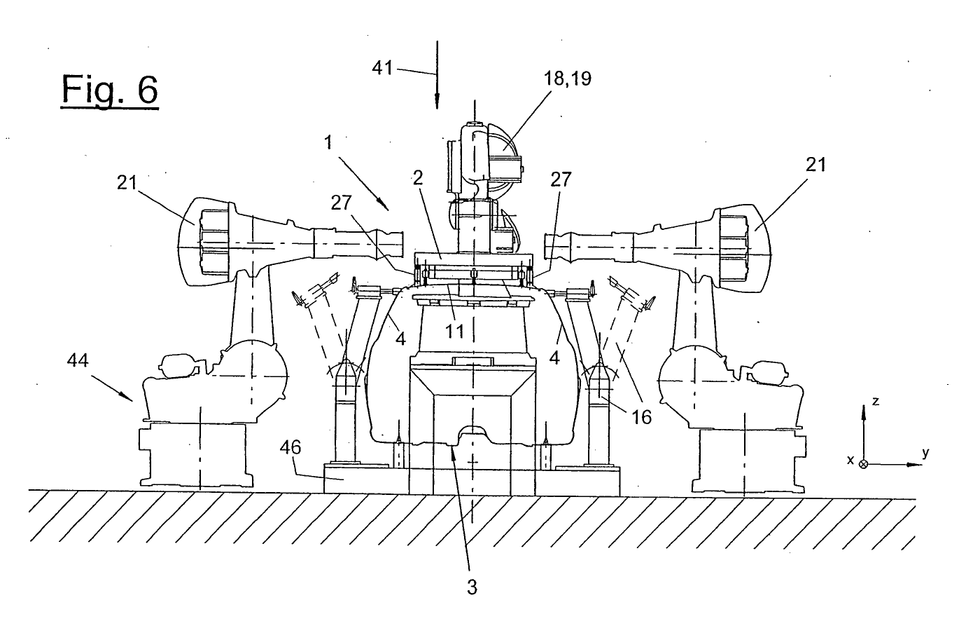

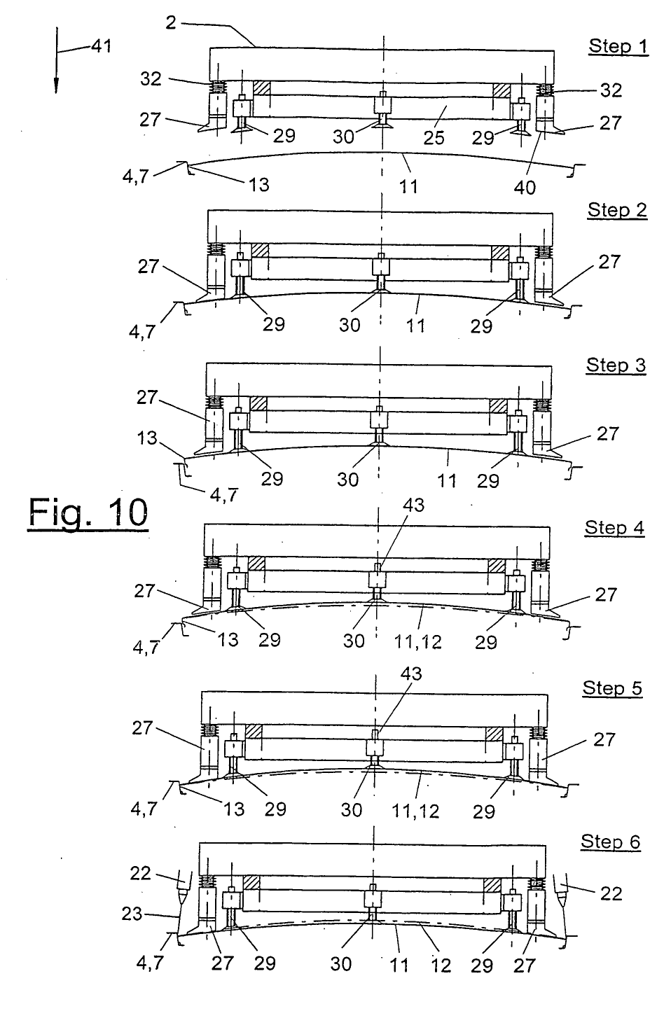

As is illustrated in the front view of the joining device (1) in FIG. 6 and the corresponding views in FIGS. 10a-f and 12a-e the gripping elements (29, 30) are arranged in the inner area of the floating frame (25) with a preferably uniform distribution, and the edge-side gripping elements (29) are arranged with a setback and at a spaced location in relation to the roof edge (13). The pressing strips (27) are in turn arranged outside the edge-side gripping elements (29), and they have a lateral distance from the projecting edge (13) of the part to be joined. The geometry of the joining gripper (2) is correspondingly coordinated with the dimensions of the roof panel (11) here. The offset of the pressing strips (27), which may also have a tapered beak or shoe shape here, offers space for a laser head (22) or another machining tool for connecting the edge (13) of the roof panel with the side panels (4).

The gripping elements arranged at the floating frame (25) are divided into inner gripping elements (30) and outer, edge-side gripping elements (29), which can be actuated separately from one another. The gripping elements (30) located on the inside and especially the gripping element (30) or gripping elements (30) arranged in the central axis have a height adjustment means (43), e.g., a spindle or a cylinder, which acts in the direction of feed (41) and makes it possible to move the roof panel (11) upward and downward in the inner area independently from the edge-side gripping elements (29) and to generate a more or less intense elastic arching (12) in the process. The edge-side gripping elements (29) yield somewhat with their spring-mounted, laterally guided suction cups, which are mounted in an articulated manner for an oblique position, against the direction of feed (41).

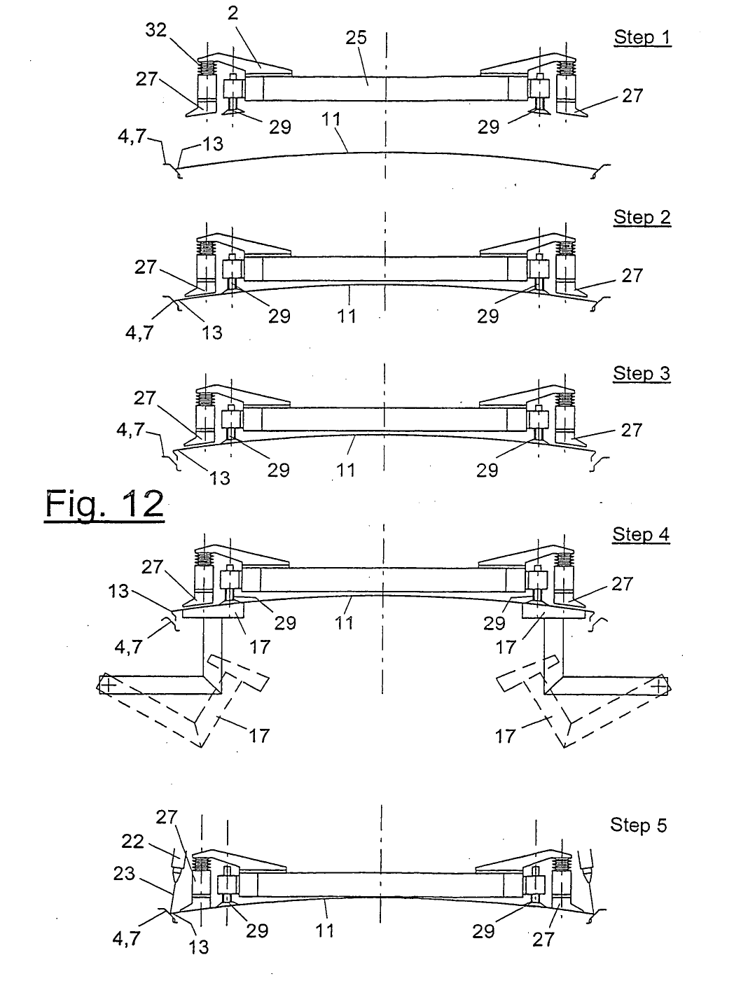

The pressing strips (27) can be moved by means of the feed device (32) in the direction of feed (41) in relation to the gripping elements (29, 30). FIGS. 10a-f and 12a-e show for this a joining sequence and motion sequence of the components of the joining gripper (2) in a plurality of steps. The above-mentioned, centrally arranged gripping elements (30) with the height adjustment means (43) are used in the variant according to FIG. 10. In the variant according to FIG. 12a-e, they may be absent without replacement or replaced with simpler gripping elements without a special height adjustment function.

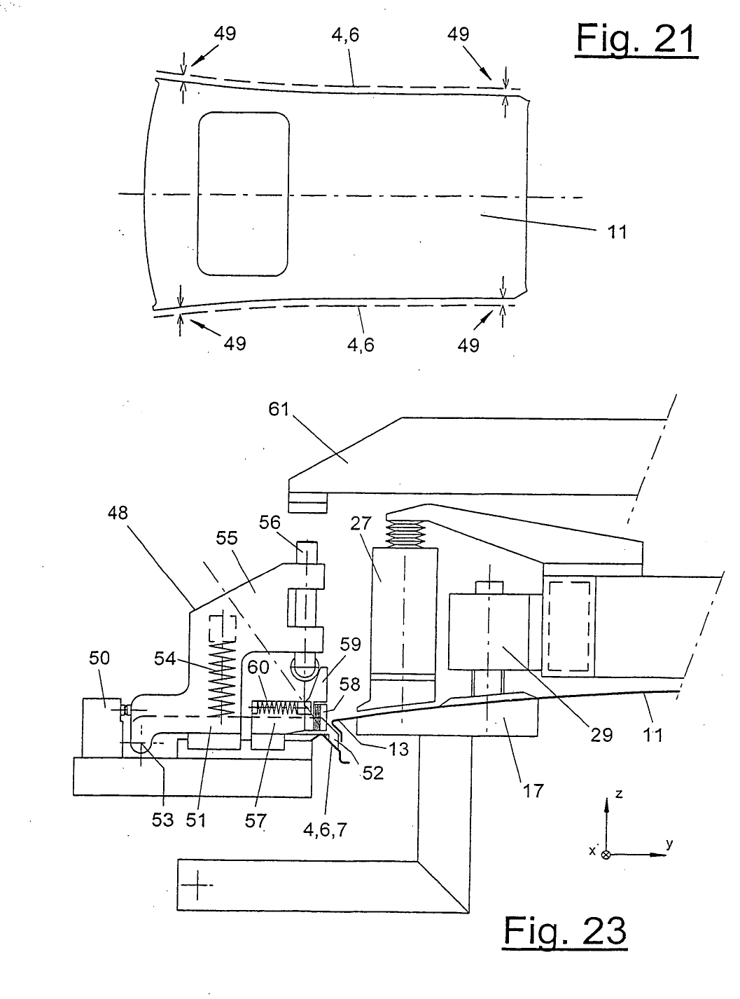

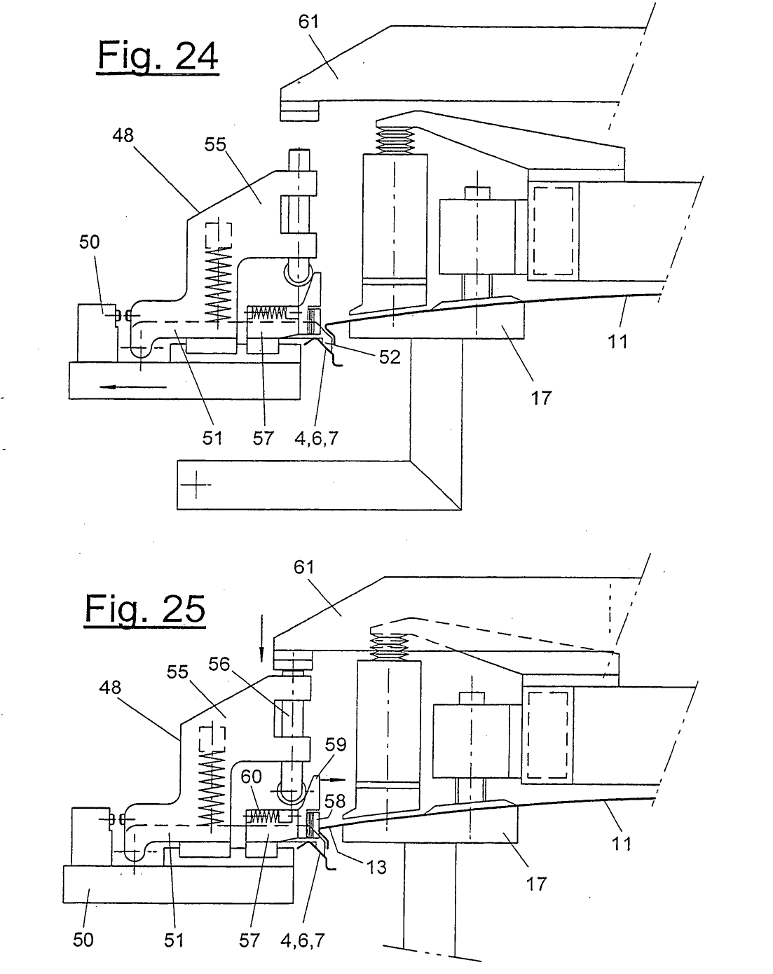

The joining sequence shown in FIG. 10a-f starts with the situation that the roof panel (11) is placed according to step 1 according to FIG. 10a by a worker or in another manner on the roof opening of the body (3) and it rests on the rabbets (5) of the side panels (4) in a position not defined more specifically. The fed means (18) lowers the joining gripper (2) onto the roof panel (11), and the gripping elements (29, 30) are activated and they entrain the roof panel (11) by suction on contact and hold it firmly. The pressing strips (27) can be pulled somewhat upward during this step of joining according to step 2 according to FIG. 10b and they may not have any contact with the roof panel (11). The joining gripper (2) with the roof panel (11) is raised in the next step 3 according to FIG. 10c and lateral centering of the roof panel (11) relative to the joining gripper (2) or relative to the components (4) may optionally take place, the latter taking place together with a centering device (47), which is shown in greater detail in FIGS. 21 through 25, and is described. The central gripping element (30) with its height adjustment means (43), which said gripping element may be present as one element or as a plurality of elements, is subsequently actuated in step 4 according to FIG. 10d and it pulls the roof panel (11) upward, which is usually already pre-arched somewhat, by an additional arching (12). During the lowering of the joining gripper (2), the roof panel (11) is brought into contact with the contact area (7) of the rabbet (5) in a subsequent step 5 according to FIG. 10e and is positioned in the process such that the edges (13) of the roof lie on the contact area (7) with a lower pressure only at best. The pressing strips (27) are subsequently lowered starting from this position and they press the roof edges (13) into tight contact with the contact areas (7), while tolerances in the joining contour (6) are absorbed and compensated. The roof panel (11) is deformed now at least elastically and possibly also permanently. Fixing of the roof edges (13) can then take place in step 6 according to FIG. 10f in the joining position by bonding, welding, soldering or according to other connection techniques. Laser heads (22), which direct a laser beam (23) toward the connection site, are preferably used for this. The machining tools or laser heads (22) may be guided by suitable machining devices (21), e.g., laterally positioned multiaxial robots, and they are moved along the roof edge (13) in the longitudinal direction. Before or during this fixing operation, the height adjustment means (43) of the central gripping element or central gripping elements (30) can again be moved back and lowered, as a result of which the excessively high arch (12) is again eliminated.

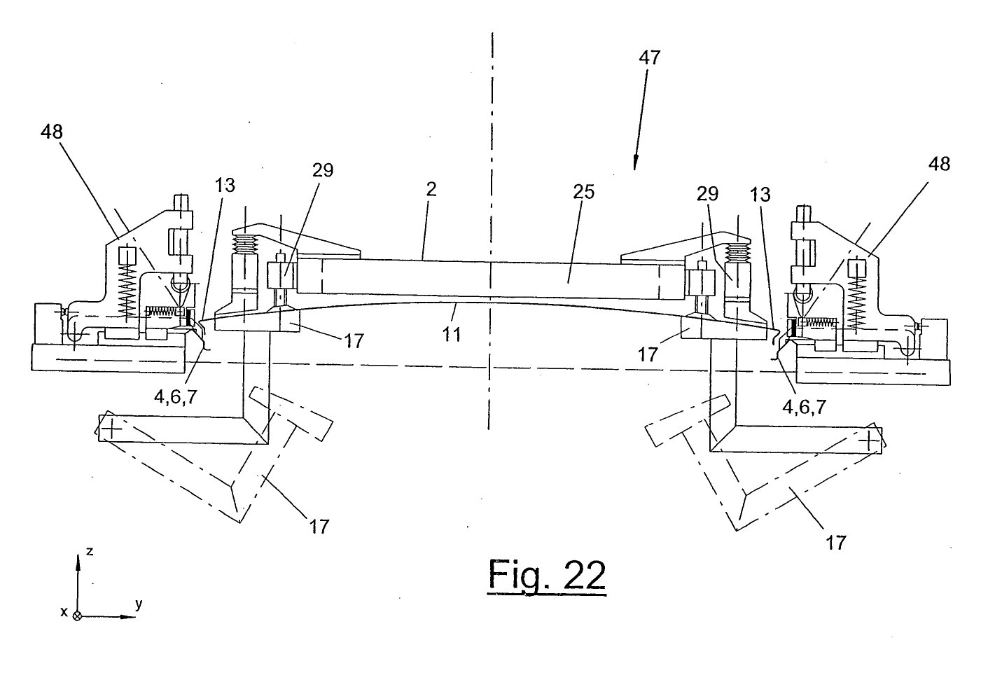

FIGS. 12a-e show a joining operation, whose course is similar, and in which the roof panel (11) does not receive an excessively high arch (12). The joining steps 1 through 3 according to FIGS. 12a-c correspond to the steps with the same numbers in FIGS. 10a-c. A centering operation, which will be explained below, is shown in step 4 of FIG. 12d. The joining device (1) has one or more movable guides (17) for the roof panel (11) for this. These are designed, e.g., as shaped centering supports and are mounted in such a way that they can be fed, especially pivoted, to a suitable location, e.g., at a clamping means (16) of the machining station (44). In the pivoted-in position indicated by solid lines, the bilateral guides (17) offer a centering support for the roof panel (11), on which it slides automatically into the correct centered position when it is briefly let go by the gripping elements (29). As an alternative, it is also possible to use the centering device shown in FIGS. 22 through 25. The gripping elements (29) subsequently take up the roof panel (11) again and bring it into a joining position, which is shown in step 5 according to FIG. 12e and again corresponds to that of step 6 in FIG. 10f with the exception of the arch (12).

In the variant according to FIGS. 5 through 7 with the multiaxial robot (19) as the feed means (18), the roof panel (11) can be joined in reference to the body, which may deviate from the reference to a network. The actual position of the side panels (4), which are kept extensively free from deformation by lateral movable clamping means (16), is used as the starting point in this case. The clamping means (16) depends here on the existing geometry of the body (3), even if this happens to be subject to tolerance. The roof panel (11) is then joined in a centered manner on the body (3).

In the variant according to FIG. 11, the joining is performed in reference to a network, i.e., according to the exact desired geometry and desired position of the body (3), which is predetermined by the construction, the clamping means (16) bringing the side panels (4) from a possibly incorrect position into the desired position predetermined by the design on the basis of the so-called reference to the network. The feed carriage (20) is directed in the direction of the x and y axes in this case after establishing the reference to the network and it joins the roof part (11) in the preset desired geometry.

FIGS. 13 through 20 show possible forms of joining the roof panel (11) and the side panels (4) in the broken-away cross section. In FIG. 13, the contact area (7) at the rabbet (5) is designed as a contact surface (8), which drops obliquely toward the inner side of the body and has a linear extension in the cross section. The two contact surfaces (8) at the left and right side panels (4) form as a result a funnel guide for receiving in a centered manner the roof panel (11), which can have a beaded edge flange (14) at the roof edge (13). The roof edge (13) lies as a result on the contact surface (8) with a rounding at the contact site (15). The gap formed in the process, which is open upwardly, is favorable for soldering, especially for the laser soldering of the parts (4, 11).

In the variant according to FIG. 14, the contact area (7) has an inwardly projecting contact step (9), with which the roof panel (11) with its edge flange (14) is in contact in a defined manner. Accurate fitting of the roof edge (13) into the contact step (9) can be accomplished by means of a deformation of the roof panel, e.g., by means of a change in the arch or by a pressing movement of the pressing strips (27).

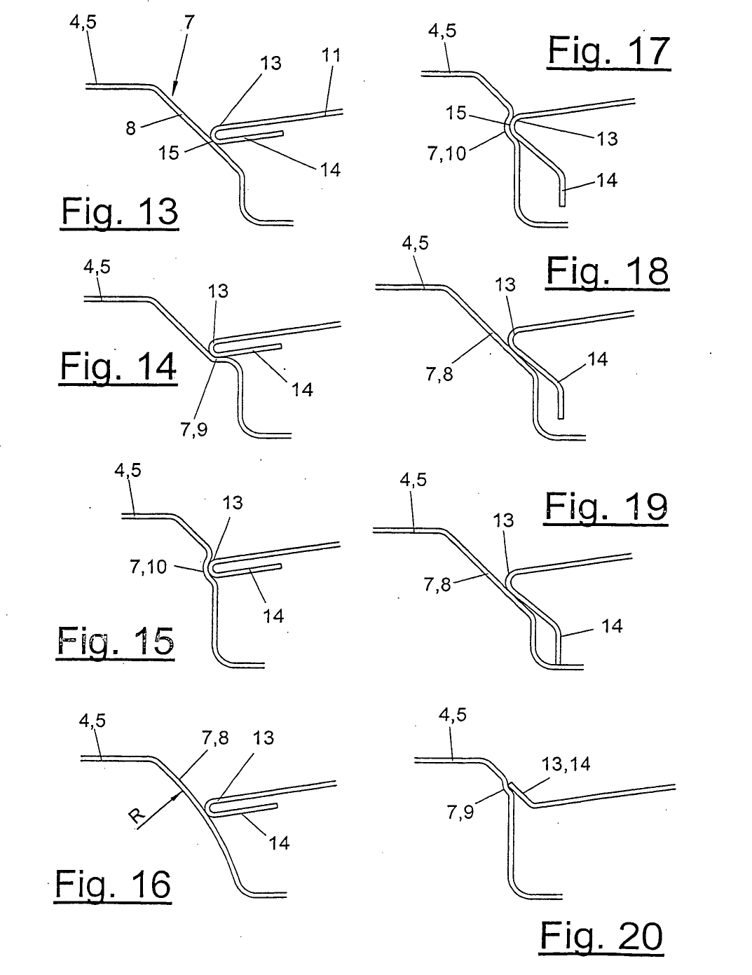

The variant according to FIG. 15 shows a positive-locking connection, which is designed, e.g., as a snap connection. A concave mount (10), into which the roof panel (11) with the edge-side rounding at the transition into the edge flange (14) can snap fittingly, is integrated in the dropping contact area (7). This is achieved in the above-mentioned manner by excessively arching the roof panel (11) and by correspondingly retracting the roof edge (13) during positioning and by a subsequent flattening of the arch of the roof panel (11) when the roof edge (13) snaps into the concave mount (10) during a transverse movement. The width of the roof panel may always have an oversize in case of this joining connection, so that the tolerance can be absorbed by a residual arch of the roof panel (11).

The variant according to FIG. 16 is a variant of FIG. 13, where the contact surface (8) directed obliquely inwardly has an arched shape and a radius R.

The variant according to FIG. 17 extensively corresponds to the variant according to FIG. 15, and the concave mount (10) and the rounding at the roof edge (13) are somewhat larger. The edge flange (14) is bent here first obliquely inwardly and, in the end area, vertically downwardly. A shape that is favorable for centering and guiding and facilitates the mutual positioning of the roof panel (11) and the side panels (4), is obtained as a result.

The shape according to FIG. 18 with the contact surface (8) with a straight cross section, with which the inwardly bent flank of the edge flange (14) is in contact with a contact area of varying size depending on the angle tolerance, also has a similar function. In FIG. 18, the lower edge of the edge flange (14) floats at a spaced location above the rabbet (5) projecting farther inwardly. In the variant according to FIG. 19, which is based on this, the rabbet (5) has a shortened height, so that the edge flange (14) additionally stands and is supported on the horizontal bottom area of the rabbet (5).

In the last variant according to FIG. 20, the edge flange (14) is bent obliquely upwardly and outwardly, unlike in the variants described so far, and it is in contact by its marginal edge on a small recessed contact step (9) of the contact area (7). Instead of the contact step (9), a slightly curved concave mount (10) may also be present. In another variant, not shown, the bent edge flange (14) according to FIG. 20 may be flatly in contact with an oblique or slightly curved contact surface (8) or have an oblique position with linear contact similarly to what is shown in FIGS. 18 and 19.

In these described variants with a contact step (9) or a concave mount (10), a defined relative position is always given between the roof panel (11) and the rabbets (5), which is secured by the pressing strips (27) during joining, and any tolerances that may exist are absorbed by a changed arching (12) of the roof panel (11) in the transverse direction. This may be permanent deformation of the roof panel (11). In the variant with the straight or rounded contact surfaces (8) and the funnel-shaped centering, roof panel tolerances can be absorbed by a changed height position at the contact area (7). The embodiments shown are all especially well suited for soldering, especially laser soldering. However, the variants with positive-locking connection via a contact step (9) or a concave mount (10) also offer special advantages over a bonded connection of the parts (4, 11), which is optionally activated or cured by supplying heat by means of a laser beam. It is otherwise possible to mutually fix the parts (4, 11) in any other suitable manner.

FIGS. 21 through 25 illustrate the centering function mentioned in the introduction and the centering device (47) used for this purpose. FIG. 21 shows a top view of a part to be joined (11), e.g., a roof panel, which is to be joined in reference to a component. The part to be joined is centered for this purpose at a plurality of, preferably four centering points (49) arranged in the corner areas relative to the two lateral components (4) or the joining contour (6).

FIGS. 22 through 25 illustrate the centering device (47) used for this. It comprises a plurality of centering units (48), which are brought into contact with the component (4) in question and the joining contour (6) by means of an articulated arm robot or in another suitable manner. The centering units (48) have all the same design and comprise a frame (50) each, which is connected to the robot or manipulator (not shown), on which a first carriage (51) or a so-called main carriage with a tracing finger (52) is arranged. The tracing finger (52) is adapted to the geometry of the joining contour (6) and the contact area (7) and has an obliquely downwardly bent shape. It is rigidly connected to the carriage (51). The main carriage (51) is relatively movable in relation to the frame (50) in at least one axis, and preferably in two axes, and, on the one hand, it can rotate about a hinge (53) in the embodiment being shown and thus it offers a motion component or possibility of yielding upwardly in the Z axis. On the other hand, the main carriage (51) can perform translatory motions in the horizontal direction and in the Y axis.

When the centering unit (48) is attached according to FIG. 23, the position of the contact area (7) at the component (4) is first searched with the tracing finger (52). Due to the above-mentioned mobilities, there is a possibility of yielding in the Z axis against the action of a spring (54), which is a rigid part of the frame, and in the Y axis against a restoring spring or the like, which is likewise present and is not shown in the drawing.

When the centering units (48) are attached, the part to be joined (11) is raised and it releases the access for the tracing finger (52) to the contact area (7). As soon as the contact finger (52) has contact with the contact area (7), the frame (50) is pulled away laterally to the outside by the robot in the Y axis, so that the tracing finger (52) has a fixed and defined contact with the contact area (7).

A second carriage or auxiliary carriage (57) is mounted on the main carriage (51) in such a way that it can perform translatory motions in the Y axis against a spring (60) connected to the main carriage (51). A deflecting means (59) for the vertical actuation, which is designed as a wedge guide in this case, is arranged at the auxiliary carriage (57). On the side of the auxiliary carriage (57) facing the part to be joined (11), a centering piece (58), which cooperates with the edge (13) of the part to be joined (11), is arranged, furthermore, on the side of the auxiliary carriage (57) facing the part to be joined (11).

A bracket (55) for a punch (56), which is movable in the Z axis and which carries at its lower end a roller or another similar part, which cooperates with the deflecting means (59) or wedge guide, is arranged on the main carriage (51). The punch (56) can be actuated by a punch drive (61) and pulled vertically upward. The punch drive (61) may be arranged at the joining gripper (2) or in any other suitable location. The punch drives (61) are actuated and moved simultaneously and synchronously in all centering units (48).

As soon as the four centering units (48) are positioned with their tracing fingers (52) at the contact areas (7) in the above-described manner, there is a reference to the component or a reference to the joining contour (6). The punches (56) are moved downward synchronously starting from this position in all centering units (58), as a result of which the auxiliary carriages (57) with the centering pieces (58) are likewise moved synchronously horizontally against the edges (13) of the part to be joined. The part to be joined (11) lies loosely on the guides (17), and the gripping elements (29) are separated or deactivated. Due to the centering pieces (58) moved forward synchronously at all four centering sites (49), the part to be joined (11) is brought into a centered position in relation to the joining contour (6) and the contact areas (7).

As soon as the centering position is assumed, the gripping elements (29) will again hold the part to be joined (11) firmly, the punch drives (61) are retracted, and the centering units (48) as well as the guides (17) are removed. The joining operation according to steps 5 and 6 in FIG. 12 can now take place from this position.

Various modifications of the embodiments shown are possible. The individual features of the exemplary embodiments described can be replaced and combined with one another as desired. In particular, the design embodiments of the joining gripper (2) and its components are variable. The pressing strip (27) may comprise, e.g., one or more rows of thin pins that are optionally spring-loaded individually or in groups, which form the strip segments. In addition, there may be spaces between the strip segments in the longitudinal direction or the x axis.

In particular, the assignment of the gripping elements (29, 30) to the pressing strips (27) may vary. For example, gripping elements (29) may be arranged between strip segments (33) through (37) spaced correspondingly from one another in the longitudinal direction. It is also possible to arrange the gripping elements (29), which are flexible in the Z direction, between the pressing strips (27) and the edges (13) of the part to be joined. The setback shown in the drawings between the pressing strips (27) and the edges (13) of the part to be joined likewise does not need to be present. It is advantageous for the accessibility of the joints and the laser heads (22). The setback may alternatively be absent, especially if the joined connection is created by contact bonding. The laser heads (22) or other connecting tools may be connected to the joining gripper (2) and carried with same.

While specific embodiments of the invention have been shown and described in detail to illustrate the application of the principles of the invention, it will be understood that the invention may be embodied otherwise without departing from such principles.

1. A joining device for joining parts to be joined to components of vehicle bodies or body shells, with one or more joining grippers, comprising
at least one frame,
a plurality of gripping elements and
a pressing element acting on the part to be joined, including a pressing strip, which is adapted to the joining contour of the component, with a feed device, wherein the pressing strip has one or more said dimensionally stable strip segments.

2. A joining device in accordance with claim 1, wherein the pressing strip has a strip carrier, which is connected to the feed device and on which the strip segments are mounted independently from one another in such a way that they have a limited flexibility in the direction of feed.

3. A joining device in accordance with claim 1, wherein the strip segments are mounted independently from one another in such a way that they have a limited flexibility about a tilt axis extending at right angles to the longitudinal axis of the pressing strip.

4. A joining device in accordance with claim 1, wherein the strip segments are mounted individually on the strip carrier in a spring-tensioned manner.

5. A joining device in accordance with claim 1, wherein the strip segments are designed as moldings with a pressing surface adapted to the joining contour.

6. A joining device in accordance with claim 1, wherein the joining gripper has a basic frame that can be connected to a feed means and a floating frame, which is movable thereon to a limited extent, wherein a plurality of said gripping elements and at least two said lateral pressing strips with their said feed devices are arranged at the floating frame.

7. A joining device in accordance with claim 1, wherein lateral frame guides for engaging the components are arranged at the floating frame.

8. A joining device in accordance with claim 1, wherein the gripping elements are mounted in such a way that they have limited mobility in the direction of feed and are laterally guided.

9. A joining device in accordance with claim 1, wherein the gripping elements are designed as suction grippers with elastically mounted suction cups.

10. A joining device in accordance with claim 1, wherein the gripping elements are arranged distributed in the inner area of the floating frame and are surrounded by the pressing strips on the outside, the pressing strips being arranged at laterally spaced locations from the projecting edge of the part to be joined.

11. A joining device in accordance with claim 1, wherein the gripping elements located on the inside have a height adjustment means.

12. A joining device in accordance with claim 1, wherein inner and outer gripping elements can be actuated separately.

13. A joining device in accordance with claim 1, wherein the joining device has at least one said mobile guide for the part to be joined.

14. A joining device in accordance with claim 1, wherein the guides are designed as shaped centering supports for the part to be joined and are arranged such that they can be fed.

15. A joining device in accordance with claim 1, wherein the joining device has a centering device oriented in relation to the component or components.

16. A joining device in accordance with claim 1, wherein the centering device has a plurality of centering units, which can be brought into contact with the joining contour, with said movable centering pieces, which can be fed synchronously against the part to be joined being held loosely at the joining gripper.

17. A joining device in accordance with claim 6, wherein the feed means for the joining gripper is designed as a multiaxial robot, wherein the part to be joined can be joined according to the existing geometry of the component.

18. A joining device in accordance with claim 6, wherein the feed means for the joining gripper is designed as a feed carriage guided in the direction of feed, wherein the part to be joined can be joined according to a network reference of the body.

19. A process for joining roof panels, to components of vehicle bodies or body shells, with one or more joining grippers, the process comprising the steps of:
providing at least one frame, a plurality of said gripping elements and a pressing element acting on the part to be joined,
pressing the part to be joined with its edge onto the contact area of the component and fixed by the joining gripper with at least one pressing strip, which is adapted to the joining contour of the component and comprises one or more, dimensionally stable strip segments.

20. A process in accordance with claim 19, wherein the part to be joined is permanently deformed during joining.

21. A process in accordance with claim 19, wherein the part to be joined with its edge is connected to a concave mount of the contact area in a positive-locking manner.

22. A process in accordance with claim 19, wherein the part to be joined with its edge is brought into contact with a flat arched contact surface of the contact area.

23. A process in accordance with claim 19, wherein the part to be joined with its edge is brought into contact with a tact step of the contact area.

24. A process in accordance with claim 1, wherein the part to be joined is elastically deformed before joining forming a arch.

25. A process in accordance with claim 1, wherein the part to be joined is fixed by laser soldering, laser ding or bonding.

26. A process in accordance with claim 1, wherein the part to be joined is centered in relation to the components or a network reference before being fixed to the joining gripper.
